(19) United States
(12) Patent Application Publication
(10) Pub. No.: US 2014/0268752 A1
(43) Pub. Date: Sep. 18, 2014

(54) LED ARCHITECTURAL LUMINAIRE HAVING IMPROVED OPTICAL AND ENVIRONMENTAL PERFORMANCE

(71) Applicant: Hubbell Incorporated, Shelton, CT (US)

(72) Inventors: Martin C Werr, Easley, SC (US); David J. Rector, Mauldin, SC (US); Raymond A. Brown, Greer, SC (US); David D. Sitarski, Greenville, SC (US); Randy K. Lewis, Greenville, SC (US)

(21) Appl. No.: 14/208,783

(22) Filed: Mar. 13, 2014

Related U.S. Application Data
(60) Provisional application No. 61/791,746, filed on Mar. 15, 2013.

(51) Int. Cl. F21S 4/00; F21K 99/00

(52) U.S. Cl. CPC F21S 4/008; F21K 9/50
USPC 362/235

(57) ABSTRACT

An LED architectural luminaire comprising a gull wing reflector, an LED mounting plate and a central lens. The mounting plate is disposed in said reflector and includes a central flat mounting surface flanked by a pair of angled mounting surfaces, each of the mounting surfaces includes a strip of LEDs. The central lens is disposed over and hingeably removably connected to the mounting plate. End caps, light seals, and optional gaskets are disposed on the ends of the luminaire.

### CROSS-REFERENCE TO RELATED APPLICATIONS

This application claims priority under 35 U.S.C. §119(e) to U.S. Provisional Application 61/791,746, filed Mar. 15, 2013, the contents of which are hereby incorporated by reference in their entirety.

### FIELD OF THE INVENTION

The present invention relates generally to LED lighting fixtures. More particularly, the present invention relates to an LED architectural luminaire having improved illumination characteristics.

### BACKGROUND OF THE INVENTION

Lighting fixtures are known in the art. Since the invention of the incandescent light bulb, or lamp, lighting fixtures housing incandescent lamps have been deployed in countless environments in countless configurations. The development of the fluorescent lamp and its concomitant energy savings led to their widespread use and placement in areas previously populated with incandescent lights. Today, fluorescent fixtures vastly predominate in many places, especially business and commercial settings where energy cost savings are amplified.

Overtime, fluorescent fixtures have been modified to not only improve upon the aesthetic look of the fixtures, but also the light scattering characteristics. As the industry shifts to newer energy saving technologies, such as light emitting diodes (LEDs), the desire to maintain the aesthetics and superior lighting characteristics of existing fluorescent fixtures remains. In other words, prior artisans are seeking to develop an LED fixture that has the aesthetically pleasing outward appearance of fluorescent fixture, while also providing the uniform light output and favorable spacing criteria of fluorescent fixtures.

A number of prior artisans have attempted to achieve these goals by replacing the elongated lamps of fluorescent fixtures with strips of LEDs. These and other prior artisans have recognized that the swapping of LEDs in the place of fluorescent bulbs does not necessarily result in the superior lighting characteristics of the original fixtures. The lighting is dramatically impacted by the limited 120° output of LEDs. Problems encountered include inferior brightness, uneven luminosity, presence of dark areas and poor spacing criteria.

In an effort to overcome these drawbacks with LED lighting fixtures, some prior artisans have attempted to increase the number or brightness of the LEDs but using multiple strips of LEDs or larger diodes. Other prior artisans have attempted to address these problems by modifying the size, shape, or angles of the reflectors and lenses of the fixtures. And still others, have attempted to address these problems by a combination of these methods. To date, those in the art have failed to solve the problems in successfully deploying LED lighting in place of traditional fluorescent lighting.

The foregoing highlights the long-felt, yet unresolved, need in the art for an LED lighting fixture that overcomes the problems in the art. The foregoing also highlights the long-felt, yet unresolved, need in the art for methods of using LEDs in a manner that results in suitable lighting characteristics.

### SUMMARY OF THE INVENTION

Various embodiments of the present invention overcome various of the drawbacks in the art and offer other advantages features as well.

According to one aspect of various embodiments of the present invention there is provided LED light fixtures having three LED arrays, gull wing reflectors, prismatic lenses and end gaskets that, in conjunction, provide a light output that rivals that of traditional fluorescent lighting.

According to an advantageous embodiment of this aspect of the invention there is provided a LED mounting plate assembly having a flat central section and opposing downwardly angled sides. Mounted along the length of the central portion and each of the angled sides are LED strips, whereby the three LED strips help serve to fully irradiate the fixture. Preferably, the angled sides are acute angles.

Another advantageous feature of this aspect of the invention is the provision of “gull wing” reflectors beneath the LED mounting plate to help spread the light to allow the fixture to achieve a desired “bat wing” light output.

Another advantageous feature of this aspect of the invention is the provision of a preferably hingeable prismatic and diffusive lens to help scatter the light and mitigate pixilation.

A related aspect of the invention is the provision of end seals to create an aesthetic end treatment that is more acceptable to room occupants and which also eliminates or shields dark areas or other anomalies in the light scattering from being perceptible by room occupants.

In a presently preferred embodiment, the angle of the angled LED mounting surfaces are at acute angles between 20° and 60° from the central surface. In a particularly preferred embodiment the angle of the mounting surfaces is between about 20 and 35 degrees.

The invention as described and claimed herein should become evident to a person of ordinary skill in the art given the following enabling description and drawings. The aspects and features of the invention believed to be novel and other elements characteristic of the invention are set forth with particularity in the appended claims. The drawings are not intended to limit the scope of the invention. The following enabling disclosure is directed to one of ordinary skill in the art and presupposes that those aspects of the invention within the ability of the ordinarily skilled artisan are understood and appreciated.

### BRIEF DESCRIPTION OF THE DRAWINGS

The above benefits and other advantages of the various embodiments of the present invention will be more apparent from the following detailed description of exemplary embodiments of the present invention and from the accompanying drawing figures, in which:

FIG. 1 depicts an exploded view of a 2′×2′ LED architectural luminaire embodiment according to the invention.

FIG. 2 depicts an exploded view of a 2′×4′ LED architectural luminaire embodiment according to the invention.

FIG. 3 is a cross-sectional view of and LED architectural luminaire of either FIG. 1 or FIG. 2.

FIG. 4 depicts several views of the central lens member of the luminaire of either FIG. 1 or FIG. 2.

The drawings are to scale where indicated on the Figures as will be clear to one of ordinary skill in the art.

### DETAILED DESCRIPTION OF THE EXEMPLARY EMBODIMENTS

While the present invention will be described in connection with embodiments of the invention designed to mimic the appearance and footprint of prior art architectural luminaires, it will be readily apparent to one of ordinary skill in the art armed with the present specification that the present invention can be applied to any suitable luminaire in any suitable environment through routine experimentation.

As shown in the exploded view of FIG. 1, the luminaire 100 includes a housing that is configured into a “gull wing” shape. The luminaire's interior surfaces are reflective to provide a “gull wing” main reflector 1 for the fixture. The bottom of the housing defines a rectangular channel that is of a suitable size to house a suitably sized LED driver 13 and preferably, other related components. On each end of the channel are brackets 10 to ensure that an LED mounting plate 200 may be attached over the channel to form an electrical component tunnel and to force LED boards 3, 4A, 4B to be suspended above the bottom curves of the gull wing reflector 1 in a manner that will be described in more detail in connection with FIG. 3.

Removably disposed above the LED mounting plate is a curved lens 9. The curved lens 9 is preferably prismatic and corresponds to the dimensions and features depicted in FIG. 4. The lens is shaped and made preferably prismatic and diffusive to shield the visibility of individual LEDs from a room occupant and/or otherwise mitigate pixilation and optimize LED performance, light scattering, and illumination.

The reflector 1 and lens 9 composite is closed on each end by an optional light seal gasket 7, light seal member 6, and end cap 8 assembly affixed to the housing. The seal assembly aids in preventing the ends of the fixture output to be visible to a room occupant, which is also helpful in optimizing LED lighting appearance.

FIG. 2 depicts and exploded view of a 2′×4′ luminaire similar to that of FIG. 1. In this embodiment, the luminaire 100 uses the same essential elements except that constituent parts are modified for the change in dimensions of the fixture to a rectangular luminaire. For example, the LED mounting plate, lens and housing each are longer and relatively narrower than those of the square embodiment of FIG. 1.

FIG. 3 depicts a cross section view of the luminaires of FIGS. 1 and 2. As shown, the luminaire 100 has a comprising a gull wing reflector 1 having defining a bottom channel 111. Disposed in the channel 111 are the LED driver 112 and related electronics for the fixture 100. Bridging the channel 111 is the LED mounting plate 200. The mounting plate 200 includes a central flat mounting surface 201, and opposing angled surfaces 202A, 202B. Disposed on each of the mounting surfaces 201, 202A, 202B is a respective LED board 3, 4A, 4B.

The LED mounting plate sides are bent on their ends to define a lens holding rail 205. The lens holding rails 205 are configured to allow the hooked ends of the central lens 9 to rest in the channel defined by the rails 205 and optionally hinge from either holding rail.

The LEDs being central and disposed angularly on each side allow their light output (which is normally 120°) to light the whole reflector and lens thereby achieving the distribution of light desired in a consistent, even and uninterrupted manner.

As best shown on FIG. 4, the lens is arcuate for aesthetic and light scattering purposes. The lens is prismatic to shield the individual LEDs from the view of a room occupant and well as aid in the desired scattering of the light.

The luminaires of the present invention may be configured as free standing or recessed fixtures. As will be appreciated by one or ordinary skill in the art armed with the present specification, the luminaire of the present invention achieves optical and environmental performance through the use of unique LED array, reflectors, lenses, and seals. The LED arrays are located and positioned precisely and coupled with a special lens composition to mitigate pixilation and optimize LED performance. The luminaires are designed to meet DLC requirements and are configurable for recessed or surface mount ceiling types. Additionally, these luminaires may be marked suitable for use in insulated ceilings, and/or may be supplied with gasketing and marked suitable for use in wet locations.

The foregoing embodiments and advantages are merely exemplary and are not to be construed as limiting the scope of the present invention. The description of an exemplary embodiment of the present invention is intended to be illustrative, and not to limit the scope of the present invention. Various modifications, alternatives and variations will be apparent to those of ordinary skill in the art, and are intended to fall within the scope of the invention.

I claim:

1. An LED architectural luminaire comprising:
a gull wing reflector housing defining a channel;
an LED driver disposed in said channel;
an LED mounting plate disposed above said channel, said LED mounting plate including a flat central mounting surface and a pair of parallel downwardly sloped surfaces;
three LED strips, one disposed on each of a respective mounting surface of said LED mounting plate; and
a central lens member, said central lens member being prismatic and disposed above said LED mounting plate.

2. The luminaire of claim 1 wherein said sloped sides are angled at a slope of about 20° to 60°.

3. The luminaire of claim 2, wherein said slope is about 30°.

4. The luminaire of claim 1, wherein said housing includes a pair of end caps.

5. The luminaire of claim 4, further comprising light seals disposed in an area adjacent said end caps.

6. The luminaire of claim 5, comprising light seals disposed in an area adjacent said end caps and gaskets.
